(19) United States
(12) Patent Application Publication
(10) Pub. No.: US 2010/0125864 A1
(43) Pub. Date: May 20, 2010

(54) MOBILE REMOTE CONTROL OF A SHARED MEDIA RESOURCE

(75) Inventors: Chris Dwyer, Durham, NC (US); Peter Lange, Durham, NC (US); Robert Clark, Chapel Hill, NC (US); John Board, Chapel Hill, NC (US); Alex Edelsburg, Hallandale, FL (US); Zachary Drillings, White Plains, NY (US)

Correspondence Address: Mauriel Kapouytian & Treffert LLP, 151 1st Avenue, #23, New York, NY, 10003, US

(73) Assignee: Duke University, Durham, NC (US)

(21) Appl. No.: 12/272,757

(22) Filed: Nov. 17, 2008

(51) Int. Cl. H04N 7/173; G06F 21/00; H04W 4/00

(52) U.S. Cl. 725/24; 726/3; 455/466; 725/119

(57) ABSTRACT

Systems and methods for controlling a shared media resource are disclosed. One embodiment includes an edge device adapted to control the media resource based on content selection votes received from users in the shared space who transmit their votes to the edge device over a wide area communication network. In a particular example, a user can submit a vote via a mobile communication method such as text messaging. In another example, votes can be submitted by interacting with a web page or an email program. In another aspect, the edge device tallies the votes and, based on a configuration setting that defines a voting policy, the edge device controls a content selection of the media resource. In another example, the edge device can also receive input from one more local remote control devices that communicate directly with the edge device such as, for example, a standard infrared remote control unit. Depending on a configuration setting, communications from such units may be treated as votes or may override votes received to control the device directly. In another aspect a server coupled to the wide area network is adapted to receive and authenticate vote messages from users in the shared space and provide corresponding vote commands to the edge device. In a particular aspect, authenticating the vote messages includes use of a code that is displayed on the edge device such that a user in the shared space must include the code with the vote message in order for the user's vote to be accounted for in determining a content selection of the shared resource. In a more particular aspect, the code is periodically changed via code updating commands sent from the server to the edge device. In another aspect, an administrative user can interact with the server over the wide area network to set up the edge device and to set or change configuration settings of the edge device. In some alternatives, votes can be tallied and content selection determined on the server rather than the edge device and then the server can send content selection commands for to the edge device for controlling the shared media resource.

### BACKGROUND

Many public or semi-public settings have a media resource (e.g. television, music player, video player, etc.) shared by one or more persons in the setting and within audio and/or visual range of the media resource. For example, bars, restaurants, night clubs, exercise facilities, student commons, airports, and many other settings often have such shared media resources. Because many of the people in such spaces often do not know each other and may come and go, it is often difficult to determine a content selection choice for the media resource that reflects the preferences of the users of that resource. Existing remote control systems and methods do not offer a satisfactory solution. For example, a resource owner might provide multiple standard remote control units in the shared space. However, such an approach has problems. It is not easy to make such units both secure from theft and freely available in the space. Also, and more importantly, such units can typically only express the preference of one user at a time, not the collective preference of multiple users. If different users of such standard units are selecting different channels, for example, conflicts might arise and the channel might change too frequently. Alternatively, some users might not feel comfortable changing the channel because it is sometimes difficult in such settings to know whether other people in the space are watching the current channel and whether such other people would find a channel change acceptable. There is therefore a need to address the currently unsolved problems associated with control of a shared media resource.

### SUMMARY

In one aspect, an embodiment of the present invention provides a method and system for facilitating control of a media resource in a shared space. In a more particular aspect, an embodiment of the present invention includes an edge device adapted to control the media resource based on content selection votes received from users in the shared space who transmit their votes to the edge device over a wide area communication network. In a particular example, a user can submit a vote via a mobile communication method such as text messaging. In another example, votes can be submitted by interacting with a web page or an email program. In another aspect of one embodiment, the edge device tallies the votes and, based on a configuration setting that defines a voting policy, the edge device controls a content selection of the media resource. In another example, the edge device can also receive input from one more local remote control devices that communicate directly with the edge device such as, for example, a standard infrared remote control unit. Depending on a configuration setting, communications from such units may be treated as votes or may override votes received from other sources, thus allowing the unit to control the shared resource directly.

In another aspect of an embodiment of the present invention, a server coupled to the wide area network is adapted to receive and authenticate vote messages from users in the shared space and provide corresponding vote commands to the edge device. In a particular aspect, authenticating the vote messages includes use of a code that is displayed on the edge device such that a user in the shared space must include the code with the vote message in order for the user's vote to be accounted for in determining a content selection of the shared resource. In a more particular aspect, the code is periodically changed via code updating commands sent from the server to the edge device. In another aspect, an administrative user can interact with the server over the wide area network to set up the edge device and to set or change configuration settings of the edge device.

In various alternatives to the disclosed embodiments, certain described functions may be performed on the edge device rather than the server and vice versa.

### BRIEF DESCRIPTION OF THE DRAWINGS

For purposes of illustration only, several aspects of particular embodiments of the invention are described by reference to the following figures.

FIG. 1 illustrates a shared resource control system including server system 150 and edge device 120. The system is in accordance with an embodiment of the present invention.

FIG. 2 illustrates edge device 120 of FIG. 1 in further detail.

FIG. 3 illustrates server system 150 of FIG. 1 in further detail.

FIG. 4 illustrates process 400 including steps carried out by message queue processor 151 of server system 150 of the embodiment illustrated in FIG. 3.

FIG. 5 illustrates process 500 including steps carried out by edge device server 155 of server system 150 of the embodiment illustrated in FIG. 3.

FIG. 6 illustrates process 600 including steps carried out by stream processor 125 on edge device 120 of the embodiment illustrated in FIG. 2.

FIG. 7 illustrates process 700 including steps carried out by remote control monitor 127 on edge device 120 of the embodiment illustrated in FIG. 2.

FIG. 8 illustrates process 800 including steps carried out by shared resource controller 122 on edge device 120 of the embodiment illustrated in FIG. 2.

FIG. 9 illustrates process 900 including steps carried out by display controller 121 for controlling display 123 of edge device 120 the embodiment illustrated in FIG. 2.

### DETAILED DESCRIPTION

The following description is presented to enable any person skilled in the art to make and use the invention, and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

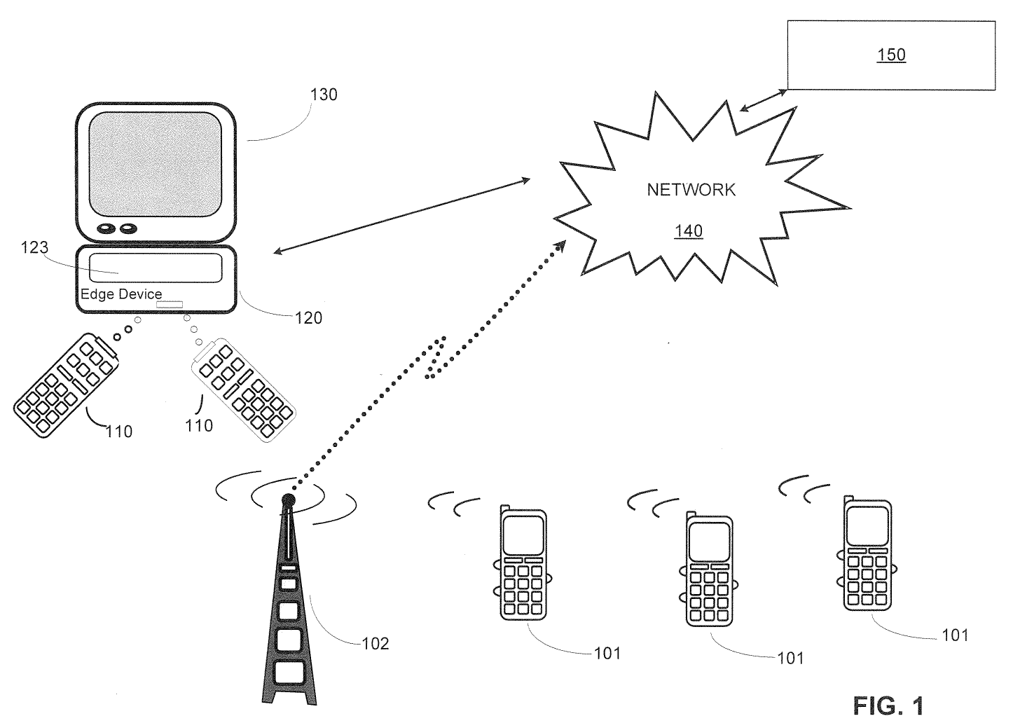

FIG. 1 illustrates a shared resource control system including server system 150 and edge device 120. The system is in accordance with an embodiment of the present invention. Edge device 120 is adapted to control a content selection of shared media resource 130. In the illustrated embodiment, shared resource 130 is a television and the content selection that edge device 120 is adapted to control is a channel to which shared resource 130 is tuned. However, in alternative embodiments, a shared media resource might be a radio, a juke box, any type of music player, a video player, a computer or any other shared resource that displays or plays any type of audio or visual media. In the case of a juke box, other music player, or other audio and/or visual media player, an edge device such as edge device 120 might control a content selection of such a resource by controlling the selection of a particular media segment that the shared resource is adapted to play (e.g. a song track, movie, sports event, program, or other media segment stored locally or streamed from a remote source).

Continuing with the example illustrated in FIG. 1, edge device 120 is adapted to receive commands from wide area communication network 140 that are transmitted by server system 150. Edge device 120 is also adapted to receive signals from local remote control devices 110. Remote control devices 110 might be an infrared (“IR”) device, a Bluetooth or other wireless device and might even be a wired device. Edge device is adapted to receive commands from remote control devices 110 directly without those commands necessarily traveling through communications network 140.

Resource 130 is shared by people within audio and/or visual range of the resource, some of whom may have local remote control devices 110 and some who may have mobile communication devices such as mobile phones 101. Mobile phones 101 are typical mobile phone devices in communication with a wireless network tower such as tower 120. The wireless network of which tower 102 is a part is further adapted to communicate messages to wide area communications network 140 which, in this example, is the Internet.

Local remote control devices 110 and mobile phone devices 101 are just two examples of devices that might be used to send messages used by edge device 120. In other examples, any computer or other remote device that can communicate with a network such as network 140 could be used as an alternative to mobile phone device 101. Also, devices that utilize various forms of wireless communication signaling that a particular edge device is adapted to receive (e.g. Bluetooth, RF signaling, or other known wireless communication methods/protocols) might be utilized as an alternative to local remote control device 110 for direct communication with the edge device.

Edge device 123 includes a display 123. Edge device 120 is adapted to receive and display a periodically changing or static code that is required to authenticate a vote message. Specifically, in order to have a vote entered by a user of a wireless device such as a mobile phone 101, the mobile phone user must key in a code and include that code in the vote message in order to have the vote counted. This prevents mobile phone users who are not in the vicinity of shared resource 130 from voting on the content selection of that resource. As alternative to using a display such as display 123 of edge device 120, an edge device might instead provide data to a display of the shared media device itself such that an unobtrusive text stream provided by the edge device is shown on the shared media resource display, thus obviating the need for a separate display dedicated solely to the edge device.

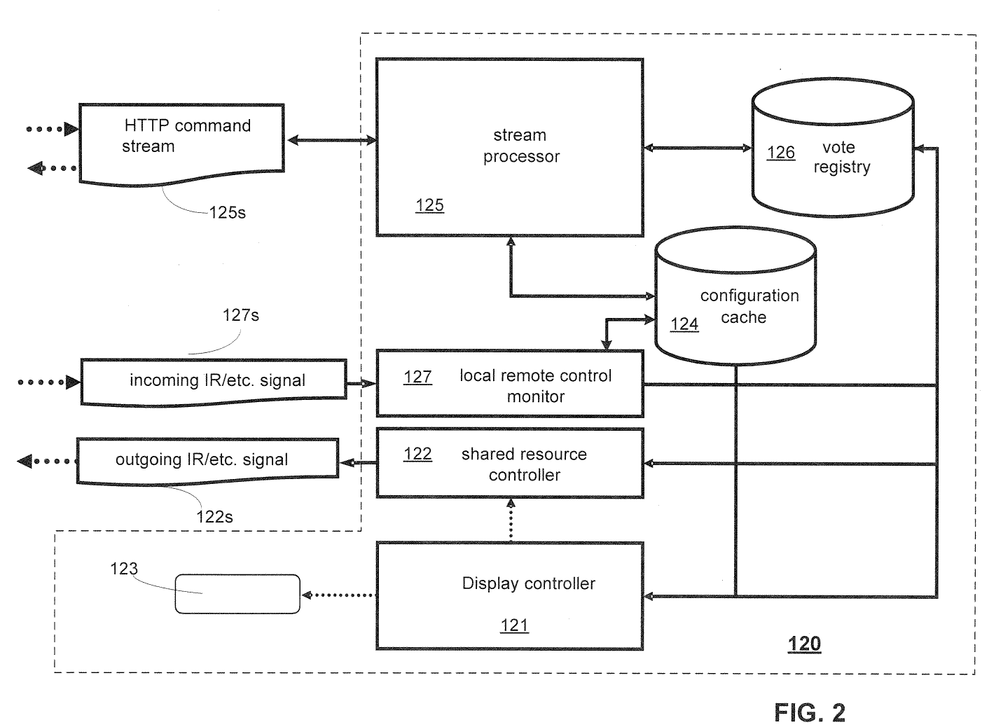

FIG. 2 illustrates edge device 120 (shown in FIG. 1) in further detail. Specifically, edge device 120 includes stream processor 125, vote registry 126, configuration cache 124, local remote control monitor 127, shared resource controller 122, and display controller 121. These functional components can be implemented on customized hardware, an embedded computer, or a generic computer (e.g. a personal computer). Preferably the functional components of edge device 120 are implemented on a single circuit board (or even on a single integrated circuit), but might alternatively be implemented by multiple units.

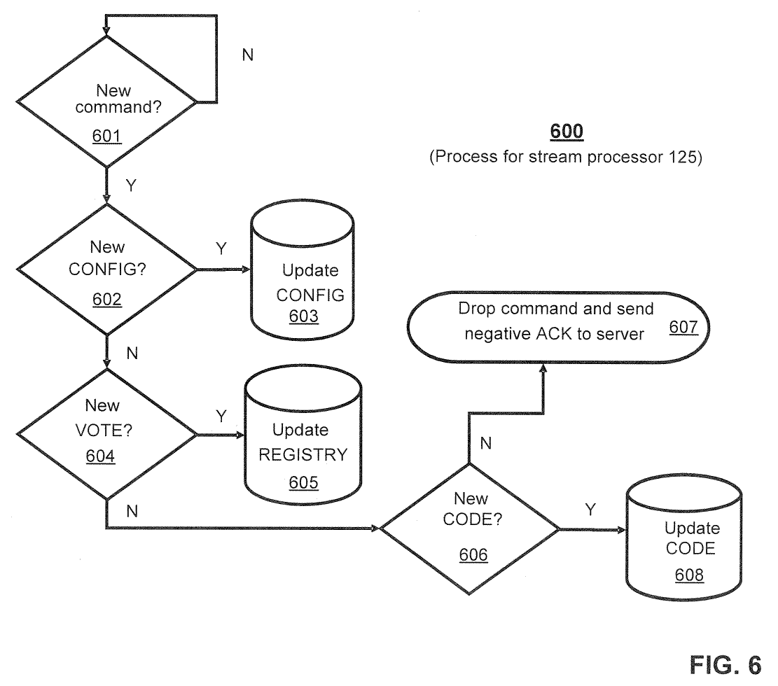

As illustrated, stream processor 125 communicates with communication network 140 (shown in FIG. 1) via HTTP command stream 125s. In the particular embodiment illustrated, HTTP command stream 125s represents communications between stream processor 125 and server system 150 (shown in FIG. 1). As described further in the context of FIG. 6, stream processor 125 determines whether it has received a vote command or a configuration command. As shown in FIG. 2, it updates vote registry 126 with any vote commands received and it updates configuration cache 124 with any configuration commands received. Stream processor 125 as well as other functional components referenced herein may be implemented simply as one or more program modules of software running on hardware or as one or more customized hardware modules that control the relevant functions of the underlying system described herein.

Remote control monitor 127 provides messages received via signal 125s to vote registry 126. In the illustrated embodiment, messages to remote control monitor 127 are sent from local remote control devices such as devices 110 shown in FIG. 1 via signal 127s. Remote control monitor 127 reads configuration information from configuration cache 124 and, depending on the configuration, provides messages received via signal 127s to either resource controller 122 or to vote registry 126.

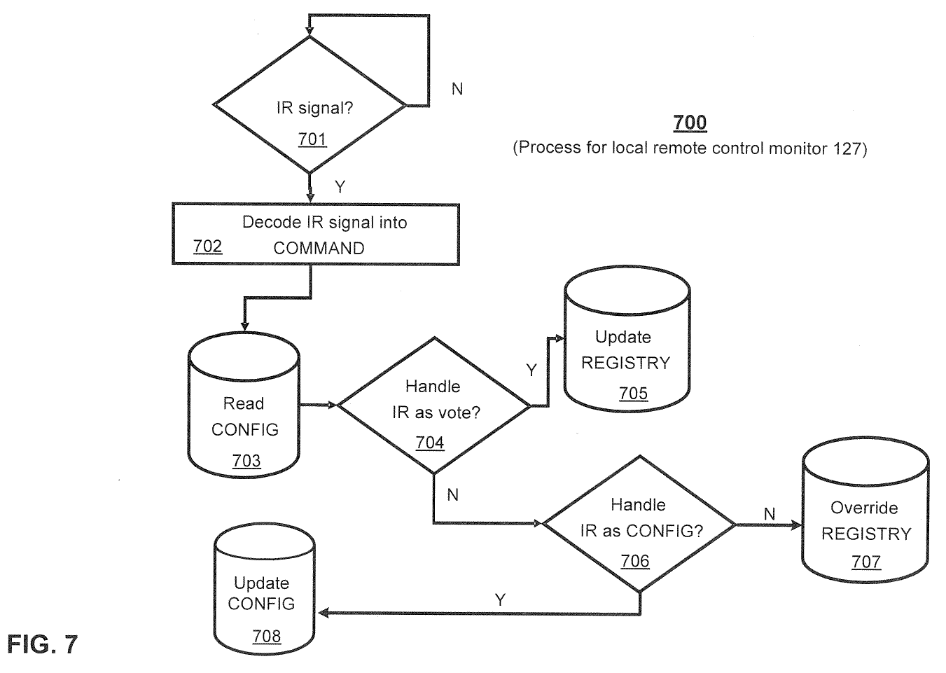

Resource controller 122 controls shared resource 130 (of FIG. 1) by sending outgoing signal 122s. In a particular implementation, this signal may be an IR signal. Such an implementation could be particularly useful if edge device 120 is used to control a plurality of shared resources. Shared resources can require specific codes to be controlled by IR signals, thereby allowing edge device 120 to send signals for controlling a selected one of a plurality of shared resources. In other implementations, a control signal such as signal 122s might be communicated via a Bluetooth signal or other wireless signal. In yet other implementations, such a signal might be communicated from an edge device to a shared media resource via a coaxial cable, fiber optic cable, network cable, universal serial bus (“USB”) or other physical line connection. Resource controller 122 controls shared media resource 130 based upon information in the current configuration, the data in vote registry 126 and, in some cases, information received directly from remote resource monitor 127 (if the configuration is set to override the vote registry as explained further in the context of FIG. 7).

Display controller 121 controls display 123 to display the most recent code required for voting. Display controller 121 receives updated codes from configuration cache 124. Display of such codes, and requiring that they be included with a voting message, helps limit voting to those who are in visual range of shared media resource 130.

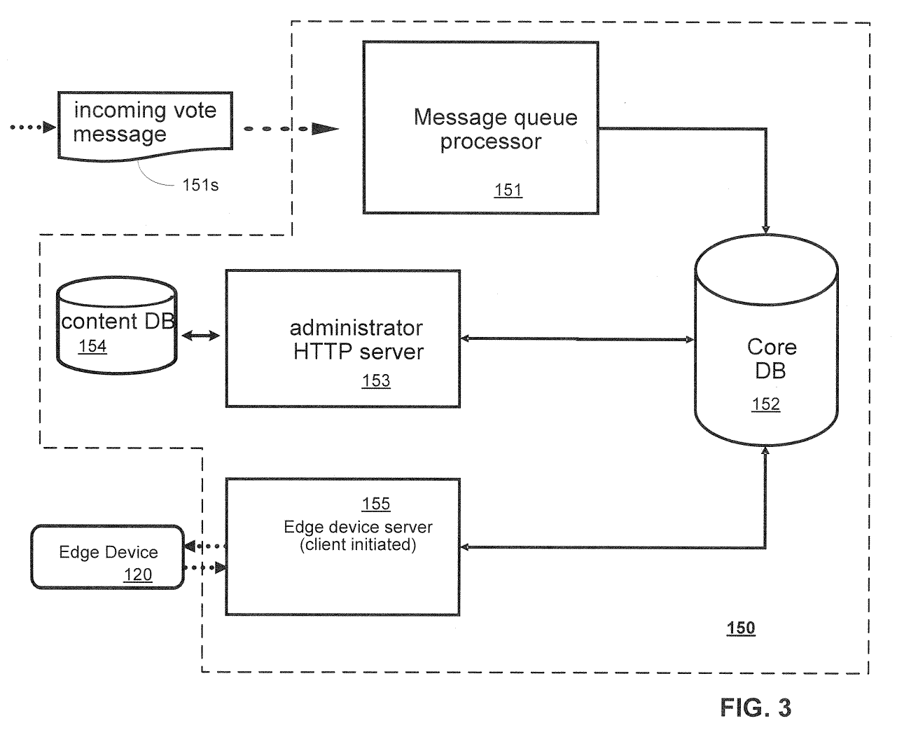

FIG. 3 illustrates server system 150 (shown in FIG. 1) in further detail. Server system 150 includes message queue processor 151, core database (“DB”) 152, administrator HTTP server 153, content DB 154, and edge device server 155. These functional components might be implemented on a single server or on multiple servers which might include one or more general purpose computers and/or customized hardware elements.

Message queue processor 151 receives messages 151s, determines if they are valid vote messages (e.g., incoming vote messages sent via a user device 101 referenced in FIG. 1) and, if so, updates core DB 152 accordingly. Edge device server 155 interacts with edge device 120 to deliver voting and configuration commands. HTTP server 153 interacts with an administrative user over an HTTP communication path. The administrative user can interact with the HTTP server for initial setup of edge device 120. For example, content DB 154 might contain control codes (e.g., IR remote control codes) for all major television brands or for various known media players. Once the administrative user indicates to HTTP administrative server 153 what type/brand of shared media resource edge device 120 needs to control, administrative server 153 can obtain the necessary configuration information from content DB 151 and place it in core DB 152 so that edge device server 155 can obtain and send it to edge device 120. An administrative user can also interact with HTTP administrator server 153 to control other configuration settings of edge device 120. For example, if an administrative user wants voting codes to be required, or wants to set a particular policy for determining a winning vote, the user can interact with administrative server 153 to make appropriate selection. Administrative server 153 will update core DB 152 accordingly, and edge device server 155 will send the necessary configuration messages to edge device 120 via network 140 (shown in FIG. 1).

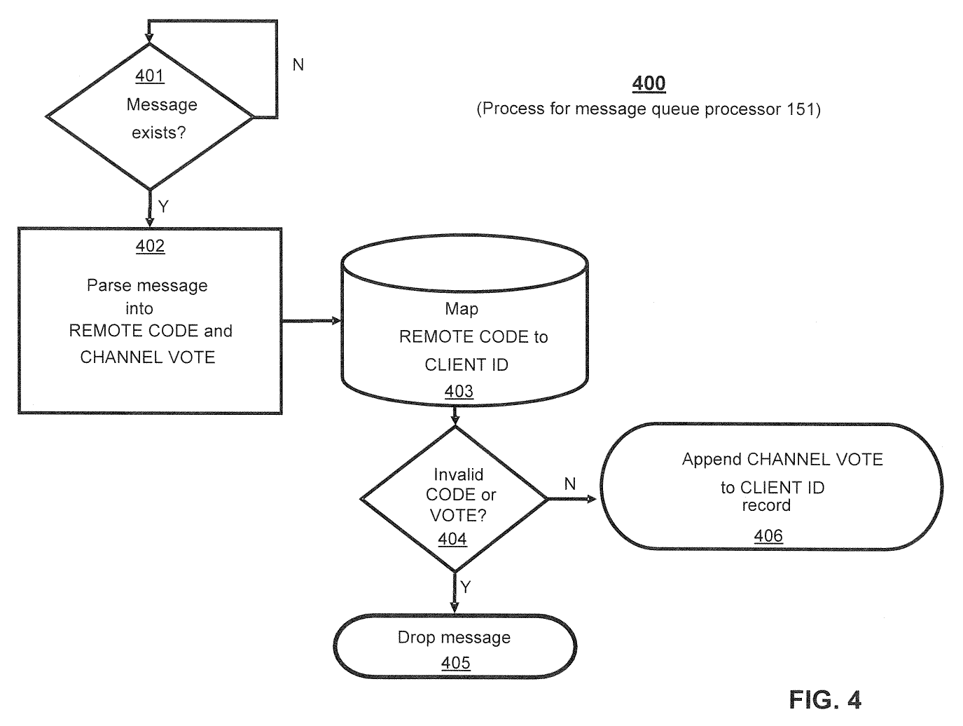

FIG. 4 illustrates process 400 including steps carried out by message queue processor 151 of server system 150 shown in FIG. 3. Step 401 repeatedly checks for incoming messages. If there is a message, step 402 parses the message into two parts: REMOTE CODE and CHANNEL VOTE. The REMOTE CODE is the code displayed by the edge device and required to be provided along with the content vote, which in this case is referred to as a CHANNEL VOTE (e.g. “ESPN,” “CNN,” “NBC,” etc.). At step 403, the process accesses core DB 152 and attempts to map the REMOTE CODE to a stored CLIENT ID associated with the REMOTE CODE. The CLIENT ID identifies a particular edge device. Step 404 determines if the REMOTE CODE or the CHANNEL VOTE is invalid. If no, the process proceeds to step 406 which appends the CHANNEL VOTE to the CLIENT ID record. If yes, then the process drops the message at step 405.

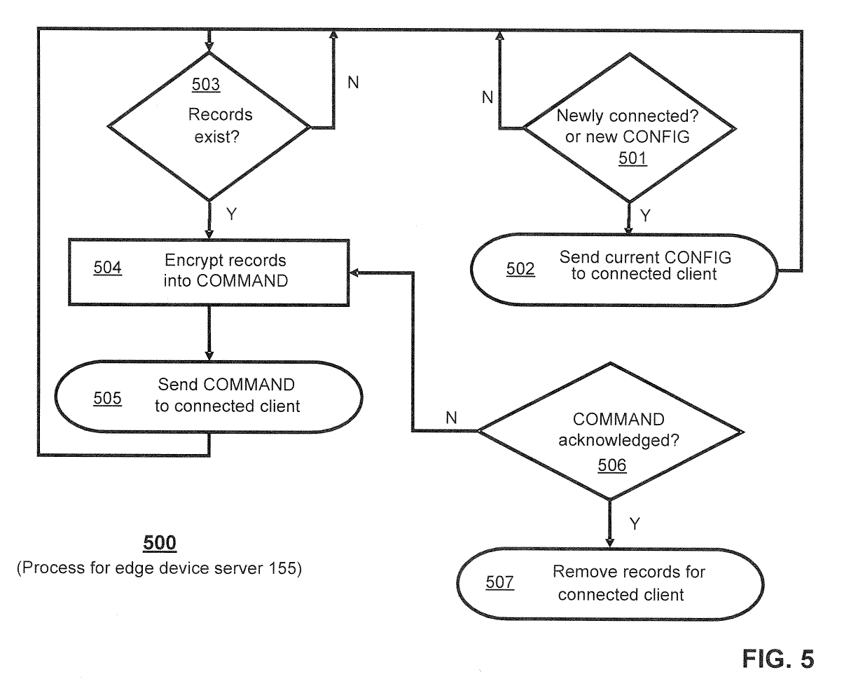

FIG. 5 illustrates process 500 including steps carried out by edge device server 155 of server system 150 shown in FIG. 3. Step 501 determines whether or not the connected edge device client is either newly connected or has new configuration information stored on the server that it has not yet received. If yes, the process proceeds to step 502 and sends the current configuration for that edge device to the connected client. After the current configuration has been sent, or if the client is not newly connected and does not require an updated configuration, the process proceeds to step 503 to determine whether any records exist for that client. Records may include data to be formulated into commands such as vote commands, configuration commands, or code commands. If no, the process loops back and keeps checking for new records for the connected client. If yes, the process proceeds to step 504 to encrypt the records into a command that is sent to the client at step 505 and the process loops back to step 503 to determine if records exist. Step 506 determines if a sent command has been acknowledge by the client. If yes, the process proceeds to step 507 which removes the records for that connected client. If no, the process proceeds back to step 504 and the records are again encrypted and sent as commands. In the illustrated embodiment, one such process 500 is initiated for each connected client.

FIG. 6 illustrates process 600 including steps carried out by stream processor 125 on edge device 120 illustrated in FIG. 2. Step 601 determines if a new command has been received. If no, the process loops back and repeats. If yes, the process determines at 602 whether or not the command is a configuration command. If yes, the process at step 603 updates configuration cache 124 (shown in FIG. 2) accordingly. If no, step 604 determines whether the command is a vote command. If yes, the process at step 605 updates vote registry 126 (shown in FIG. 2) accordingly. If no, step 606 determines whether the command is a new code. If yes, the process at step 608 updates the code and the new code is displayed by display controller 121on display 123 of edge device 120 (all shown in FIG. 2). If no, then the process at step 607 drops the command and sends a negative acknowledgement message to edge device server 152 of server system 150 (shown in FIG. 3).

FIG. 7 illustrates process 700 including steps carried out by remote control monitor 127 on edge device 120 (shown in FIG. 2). Step 701 determines if there is a signal (e.g., an IR signal) from a local remote control device 110 (shown in FIG. 1). If no, the process loops back and repeats. If yes, step 702 decodes the signal into a command. At step 703, the monitor reads the configuration in configuration cache 124 (shown in FIG. 2). Based on the configuration, the process determines, at step 704, whether the command should be treated as a vote. If yes, then the process at step 705 updates vote registry 126 (shown in FIG. 2). If no, then step 706 determines whether the command should be treated as a configuration change. If yes, then step 708 updates configuration cache 124 (shown in FIG. 2) accordingly. If no, then step 707 overrides the vote registry and the command is used directly by shared resource controller 122 (shown in FIG. 2) to control shared resource 130 (shown in FIG. 1).

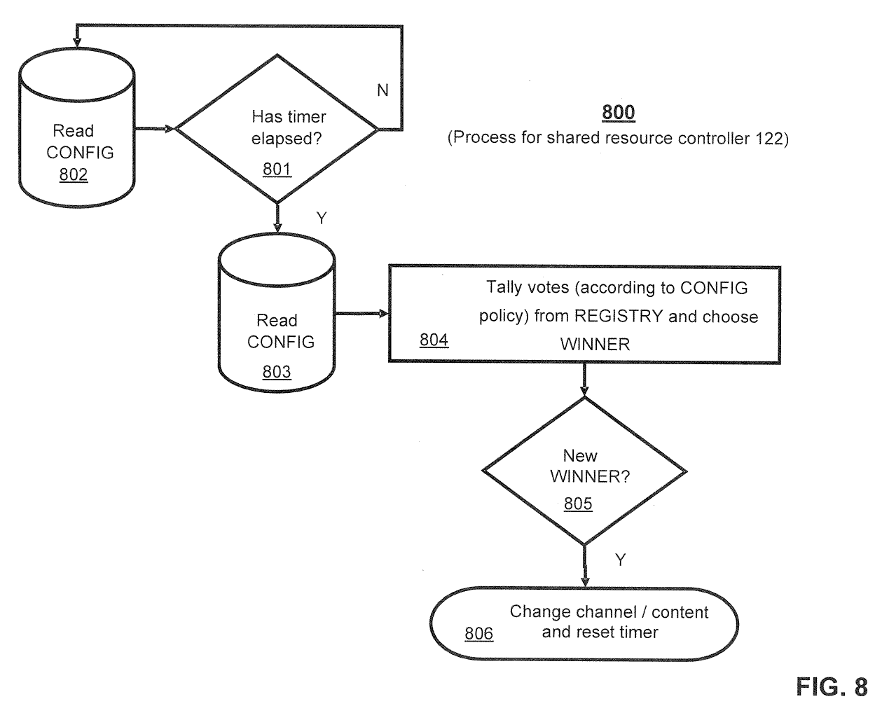

FIG. 8 illustrates process 800 including steps carried out by shared resource controller 122 on edge device 120 (shown in FIG. 2). Step 801 determines if a timer period has elapsed. The timer period ensures that the content selection of the shared media resource is stable for a period of time prior to new votes triggering a content selection change. If no, the process at step 802 reads the configuration from configuration cache 124. If yes, step 803 reads the configuration from configuration cache 124 and then step 804 tallies the votes from vote registry 126 using the vote policy provided by the configuration.

There are a variety of possible vote policies that might be used by step 804 to determine one or more winners. It might be that a simple majority (or largest plurality) wins and the resource displays the winning content selection accordingly. Alternatively, for example, an initial set amount of viewing time might be provided for the content selection of the majority (or largest plurality), and then the selection might rotate to a content selection voted for by the next largest plurality, and so on. In other alternatives, the resource might be split into N portions and each portion would be devoted to a content selection indicated by one of the top N pluralities of votes. For example, if an edge device controls multiple televisions in the same shared space, each television might be tuned to show a selection of a particular one of the top N pluralities of votes. Alternatively, for a single resource such as a television that has split screen (or picture-in-picture) capability, a voting policy might dictate showing multiple channels on the screen for the top N pluralities with the majority (or largest plurality) selection dictating the channel for which audio is played. In other variations, users might vote in advance for selecting a particular channel during a particular time window. As another alternative, the number of votes for a particular content selection could be used to determine the duration for which that content selection is displayed, with other content selections being displayed subsequently. A configuration voting policy might also provide for contingencies in the event of a tie, such as, for example, randomly adding a vote to one of the tied results to force a “winner.”

After a winner has been determined, step 805 determines if it is a new winner (relative to the prior winning content selection). If yes, then at step 806 the new content selection (e.g. channel or media segment) is displayed (and/or played) by the shared media resource and the timer utilized by step 801 is reset.

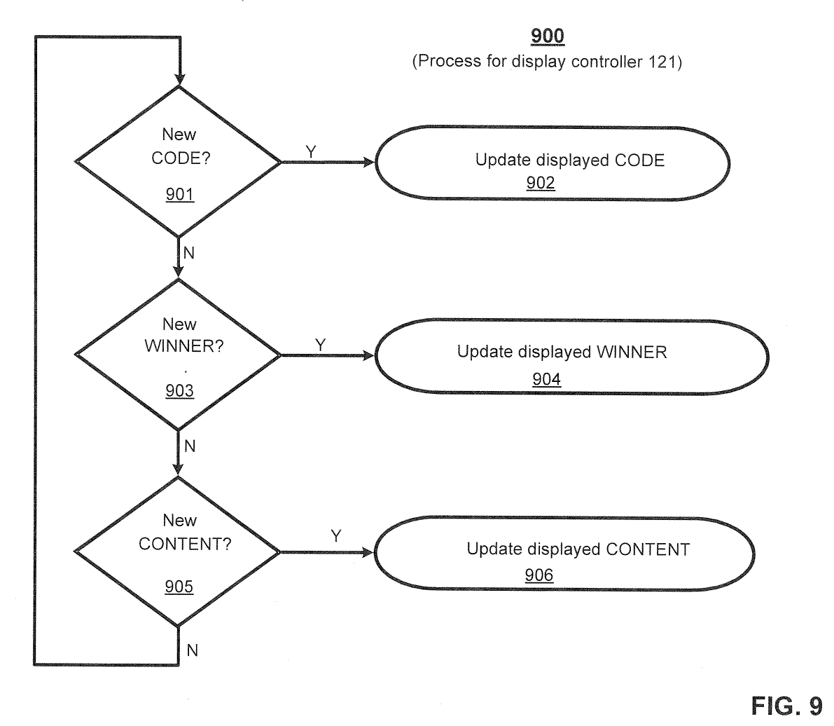

FIG. 9 illustrates process 900 including steps carried out by display controller 121 for controlling display 123 of edge device 120 (all shown in FIG. 2). Step 901 determines if a new code (for vote authentication) has been received. If yes, then step 902 updates the displayed code on display 123 of edge device 120. If no, then step 903 determines if a new winner (e.g. a winning channel selection or media segment) has been determined. If yes, then step 904 displays the name of the winning content selection on display 123. If no, then step 905 determines if there is new display content (e.g. instructions or other information) to be displayed on display 123. If yes, then step 906 updates the displayed code on display 123. If no, then the process returns to step 901 and repeats.

While the present invention has been particularly described with respect to the illustrated embodiments, it will be appreciated that various alterations, modifications and adaptations may be made based on the present disclosure, and are intended to be within the scope of the present invention. To cite just one example, in alternative embodiments, some of the functionality performed by server system 150 as described above might instead be performed by the edge device itself. For example, in such an alternative, vote messages from users might be received across the wide area network directly at the edge device without first being processed by a remote server such as server system 150 and the functionality of message queue processor 151 shown in FIG. 3 might instead be incorporated into the edge device itself. To cite but one other example, some of the functionality of edge device 120 described above might instead be performed by a server system across the wide area communications network. In such an alternative, for example, vote results might be fully tabulated and content selection commands determined at a remote server instead of locally at the edge device itself. In such an alternative, the remote server would transmit content selection commands rather than vote commands to the edge device. These and other alternatives will be apparent to one skilled in the art as not necessarily departing from the spirit and scope of the present invention. While the invention has been described in connection with what are presently considered to be the most practical and preferred embodiments, it is to be understood that the present invention is not limited to the disclosed embodiments but only by the following claims.

What is claimed is:

1. An edge device of a shared media resource remote control system, the edge device comprising:
a stream processor adapted for processing content selection votes received via a wide area communication network, the votes corresponding to one or more vote messages transmitted by users of the shared media resource, the vote messages corresponding to content selection preferences of the users; and
a resource controller adapted to control a content selection of the shared resource based on votes received by the stream processor.

2. The edge device of claim 1 wherein the stream processor is adapted to receive votes by receiving the vote messages directly from the users via the wide area communication network.

3. The edge device of claim 1 wherein the stream processor is adapted to receive votes in the form of vote commands formulated by a server system based on one or more of the vote messages, the server system being coupled to the wide area communication network for receiving the vote messages from the users and for transmitting the vote commands to the edge device.

4. The edge device of claim 2 wherein the edge device is further adapted to display a periodically changing code for use by the users to include as part of a vote message and the edge device is adapted to authenticate the vote message using the periodically changing code.

5. The edge device of claim 3 wherein the edge device is further adapted to display a periodically changing code for use by the users to include as part of a vote message and the edge device receives vote commands formulated by the server system based upon vote messages authenticated by the server system using the periodically changing code.

7. The edge device of claim 1 wherein the content selection preference relates to a channel of the shared resource.

8. The edge device of claim 1 wherein the content selection preference relates to a media segment playable on the shared resource.

9. The edge device of claim 1 wherein the edge device further comprises a configuration cache adapted to receive configuration information and the resource controller is adapted to use configuration information defining a voting policy to determine a content selection based on a result of a voting tally.

10. A shared resource control server system comprising:
a message queue processor adapted to process incoming vote messages initiated by users of a shared media resource and relating to a content selection preference for the shared media resource, the shared media resource being coupled to be controlled by an edge device that is adapted to communicate with the resource control server system over a wide area communication network; and
an edge device server adapted to transmit vote commands over the wide area communication network to the edge device based on at least some of the incoming vote messages processed by the message queue processor.

11. The shared resource control server of claim 10 wherein the message queue processer is adapted to receive vote messages that have been initiated as text messages from mobile phone devices.

12. The shared resource control server of claim 10 wherein the edge device server is also adapted to transmit configuration commands over the wide area communication network to the edge device.

13. The shared resource control server system of claim 11 wherein the server system is also adapted to authenticate the vote messages using a code included in a vote message such that only authenticated vote messages are converted to vote commands to be transmitted to the edge device.

14. The shared resource control server system of claim 13 wherein the server system is also adapted to periodically send an updated code to the edge device for display on the edge device and to associate the updated code with identification data of the edge device in a database of the server system.

15. A method of controlling content selection of a shared media resource comprising:
receiving content selection votes transmitted over a wide area network at an edge device coupled to control a content selection of the shared media resource, the content selection votes corresponding to vote messages initiated at mobile devices by users of the shared media resource; and
using the edge device to control a content selection of the shared media based on a tally of the content selection votes.

16. The method of claim 15 wherein the votes received include the vote messages themselves.

17. The method of claim 15 wherein the votes received include vote commands generated in response to the vote messages by a server system coupled to receive the vote message from the mobile devices over a wide area network and coupled to communicate the vote commands over a wide area network to the edge device.

18. The method of claim 15 further comprising:
displaying a periodically changing code for the users to include as part of a vote message; and
using the code to require that the vote be authenticated as a condition of utilizing the vote messages to determine a content selection.

19. The edge device of claim 15 wherein the content selection votes relate to a channel of the shared resource.

20. The method of claim 15 wherein the content selection preference relates to a media segment playable on the shared resource.

21. An edge device of a shared media resource remote control system, the edge device comprising:
a resource controller adapted to control a content selection of the shared resource based on content selection commands received over a wide area network from a shared resource control server system, the shared resource control server system being adapted to receive vote messages transmitted over a wide area network by users of the shared media resource, the vote messages corresponding to content selection preferences of the users and the shared resource control server being further adapted to use the vote messages in determining the content selection command.

22. The edge device of claim 21 wherein the content selection preference relates to a channel of the shared resource.

23. The edge device of claim 21 wherein the content selection preference relates to a media segment playable on the shared resource.

24. A shared resource control server system comprising:
a message queue processor adapted to process incoming vote messages initiated by users of a shared media resource and relating to a content selection preference for the shared media resource, the shared media resource being coupled to be controlled by an edge device that is adapted to communicate with the resource control server system over a wide area communication network;
a resource control module adapted to tally votes corresponding to at least some of the vote messages, and, based on a vote tally, determine a content selection command for the edge device; and
an edge device server adapted to transmit content selection commands over the wide area communication network to the edge device based on at least some of the incoming vote messages processed by the message queue processor.

25. The shared resource control server of claim 24 wherein the message queue processer is adapted to receive vote messages that have been initiated as text messages from mobile phone devices.

26. The shared resource control server of claim 24 wherein the edge device server is also adapted to transmit configuration commands over the wide area communication network to the edge device.

27. The shared resource control server system of claim 24 wherein the server system is also adapted to authenticate the vote messages using a code included in a vote message such that only authenticated vote messages are used in the vote tally.

28. The shared resource control server system of claim 27 wherein the server system is also adapted to periodically send an updated code to the edge device for display on the edge device and to associate the updated code with identification data of the edge device in a database of the server system.

29. A shared media resource control system comprising:
edge device means for controlling a shared media resource; and
server means for receiving vote messages from users of the shared media resource and for authenticating the vote messages based upon a code associated with the edge device means, the server means also being for communicating commands to the edge device means across a wide area network, the commands being used to control a content selection of the shared media resource.

30. The shared media resource of claim 29 wherein the commands are vote commands and the edge device means is also for using the vote commands to determine a content selection.

31. The shared media resource of claim 29 where the commands are content selection commands and the server means is also for using the vote messages to determine a content selection.
